(19) United States
(12) Patent Application Publication
(10) Pub. No.: US 2024/0159862 A1
(43) Pub. Date: May 16, 2024

(54) PASSENGER DETECTION DEVICE, DRIVER MONITORING SYSTEM, AND DISPLAY DEVICE

(71) Applicant: Mitsubishi Electric Corporation, Tokyo (JP)

(72) Inventor: Yuki SUSUMAGO, Tokyo (JP)

(73) Assignee: Mitsubishi Electric Corporation, Tokyo (JP)

(21) Appl. No.: 18/280,500

(22) PCT Filed: Apr. 20, 2021
(86) PCT No.: PCT/JP2021/015936

§ 371 Date: Sep. 6, 2023

(51) Int. Cl. G01S 7/02; B60R 1/29; G01S 7/41; G06F 3/01

(52) U.S. Cl. CPC G01S 7/028; B60R 1/29; G06F 3/017; G01S 7/415

(57) ABSTRACT

A passenger detection device for detecting a passenger in a vehicle in which a display device is disposed in such a way as to face a front seat ahead of the front seat, includes: a transmission unit that is mounted on the display device and transmits a radio wave to a vehicle interior; and a reception unit that is mounted on the display device and receives a reflected radio wave of the radio wave transmitted by the transmission unit.

### TECHNICAL FIELD

The present disclosure relates to a passenger detection device for detecting a passenger in a vehicle in which a display device is disposed in such a way as to face a front seat ahead of the front seat.

### BACKGROUND ART

Conventionally, there is known a technique in which a radio wave sensor as a passenger detection device is disposed in a vehicle, and a passenger in a vehicle interior is detected (for example, Patent Literature 1).

### CITATION LIST

### Patent Literature

Patent Literature 1: JP 2018-202921 A

### SUMMARY OF INVENTION

### Technical Problem

In order to accurately detect a passenger to be detected in a vehicle, a passenger detection device is preferably disposed in such a manner that a radio wave is transmitted to the passenger from a position facing the passenger, such as an instrument panel (hereinafter, referred to as “instrument panel”).

However, in most vehicles, a display device is disposed at a position where the passenger detection device is preferably disposed in such a manner that the passenger can easily visually recognize the display device.

Therefore, there is a problem that the passenger detection device cannot be disposed at a position where the passenger detection device is preferably disposed in a vehicle.

The present disclosure has been made in order to solve the above problem, and an object of the present disclosure is to provide a passenger detection device disposed at a position where the passenger detection device is preferably disposed in a vehicle.

### Solution to Problem

A passenger detection device according to the present disclosure is a passenger detection device to detect a passenger in a vehicle in which a display device is disposed in such a way as to face a front seat ahead of the front seat, and includes: a transmission unit mounted on the display device, to transmit a radio wave to an interior of the vehicle; and a reception unit mounted on the display device, to receive a reflected radio wave of the radio wave transmitted by the transmission unit.

### Advantageous Effects of Invention

According to the present disclosure, it is possible to provide a passenger detection device disposed at a position where the passenger detection device is preferably disposed in a vehicle.

### BRIEF DESCRIPTION OF DRAWINGS

FIGS. 1A and 1B are diagrams for describing an outline of a passenger detection device according to a first embodiment, in which FIG. 1A is a front view of an entire instrument panel in which the passenger detection device is disposed in a vehicle, and FIG. 1B is a diagram illustrating an example of the passenger detection device disposed as illustrated in FIG. 1A as viewed from above.

FIG. 2 is a diagram for describing examples of a display device in each of which the passenger detection device is mounted on a place other than an upper side of an outer frame in the first embodiment.

FIG. 3 is a diagram illustrating a configuration example of a driver monitoring system according to the first embodiment.

FIG. 4 is a diagram illustrating an example of a state of a vehicle interior as viewed from the display device in the first embodiment.

FIG. 5 is a diagram illustrating an example of a state in which a passenger is performing a gesture for performing a desired operation as viewed from the display device in the first embodiment.

FIG. 6 is a diagram illustrating an example of a state in which the passenger detection device detects an infant left behind on a rear seat in the first embodiment.

FIG. 7 is a flowchart for describing an operation of a passenger monitoring device according to the first embodiment.

FIGS. 8A and 8B are each a diagram illustrating an example of a hardware configuration of the passenger monitoring device according to the first embodiment.

FIG. 9 is a front view of an entire instrument panel in a vehicle in the first embodiment in a case where the display device on which the passenger detection device is mounted is erected on an upper surface of the center of the instrument panel in a vehicle width direction.

FIG. 10 is a front view of an entire instrument panel in a vehicle in the first embodiment in a case where the display device on which the passenger detection device and an imaging device are mounted is disposed at the center of the instrument panel in a vehicle width direction.

### DESCRIPTION OF EMBODIMENTS

Hereinafter, an embodiment of the present disclosure will be described in detail with reference to the drawings.

### First Embodiment

A passenger detection device according to a first embodiment is specifically a radio wave sensor. The passenger detection device is mounted on a vehicle, and is used to monitor a state of a passenger in a so-called “Driver Monitoring System (DMS)”. In the first embodiment, passengers whose states are to be monitored in the driver monitoring system are a driver in a driver's seat and a passenger in an assistant driver's seat (hereinafter, referred to as “assistant driver's seat passenger”). In the following first embodiment, a “front seat” refers to a driver seat, an assistant driver's seat, or both the driver seat and the assistant driver's seat. In addition, in the first embodiment, a driver and an assistant driver's seat passenger to be detected are also collectively referred to as “passenger”.

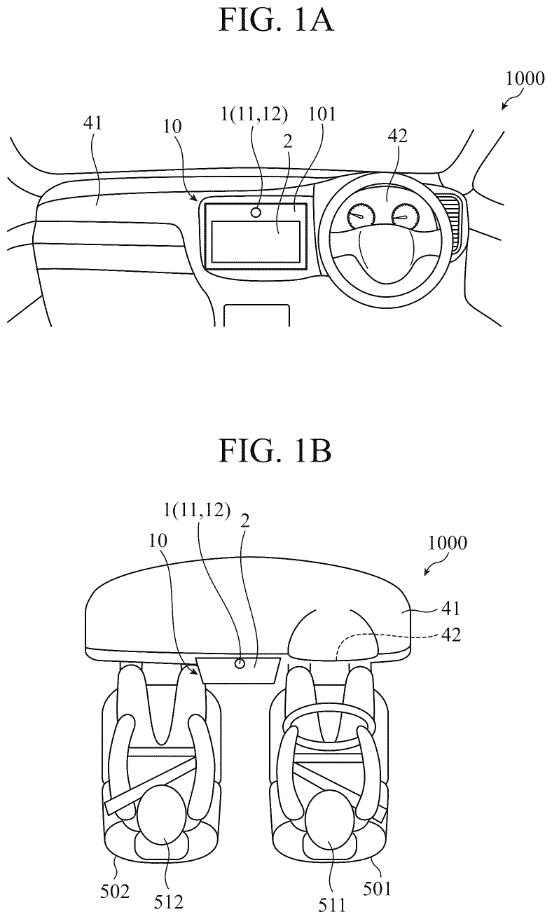

FIG. 1 is a diagram for describing an outline of a passenger detection device 1 according to a first embodiment.

FIG. 1A is a front view of an entire instrument panel 41 in which the passenger detection device 1 is disposed in a vehicle 1000, and FIG. 1B is a diagram illustrating an example of the passenger detection device 1 disposed as illustrated in FIG. 1A as viewed from above.

Note that, in FIG. 1B, only a front seat is illustrated as a seat of the vehicle 1000, and a rear seat is not illustrated. In addition, in FIG. 1B, an outer frame 101 is not illustrated for simplicity of description. In addition, although the vehicle 1000 illustrated in FIGS. 1A and 1B is a right-hand drive vehicle, this is merely an example. The vehicle 1000 may be a left-hand drive vehicle.

As illustrated in FIGS. 1A and 1B, the instrument panel 41 extending in a vehicle width direction below a front windshield (not illustrated) is disposed in a front portion of a vehicle interior.

In addition, a display device 10 is disposed at the center of the instrument panel 41 in the vehicle width direction. Note that, in the first embodiment, the center in the vehicle width direction is not necessarily strictly the center, but includes a substantially center.

The display device 10 is fitted into an opening which is formed at the center of the instrument panel 41 in the vehicle width direction and which is formed on a rear surface of the instrument panel 41 in a front-rear direction of the vehicle 1000.

The display device 10 includes a display unit 2 and the outer frame 101 surrounding the display unit 2. The display unit 2 is, for example, a touch panel display in which a touch screen is disposed on a front surface of a flat display such as a liquid crystal display or an organic EL display.

By the display device 10 being disposed at the center in the vehicle width direction, the display unit 2 can be easily visually recognized by both a driver 511 in a driver's seat 501 and an assistant driver's seat passenger 512 in an assistant driver's seat 502.

Note that a meter panel 42 is disposed at a position facing the driver's seat 501.

The passenger detection device 1 is mounted on the display device 10 and includes a transmission unit 11 that transmits a radio wave to a vehicle interior and a reception unit 12 that receives a reflected radio wave of the radio wave transmitted by the transmission unit 11 from the vehicle interior. The passenger detection device 1 is, for example, a millimeter wave radar using a radio wave in a 24 GHz band or a 60 GHz band.

In the passenger detection device 1, the transmission unit 11 transmits a radio wave, and the reception unit 12 receives a reflected radio wave that returns to the passenger detection device 1 by the radio wave being reflected by a reflection object, here, a passenger. The passenger detection device 1 thereby detects a distance and an angle to the passenger, and a movement speed of the passenger.

As illustrated in FIG. 1A, the transmission unit 11 and the reception unit 12 of the passenger detection device 1 are mounted on an upper side of the outer frame 101 in a state where the display device 10 is disposed. Note that, in FIG. 1A, the passenger detection device 1 is mounted on a substantially center of the upper side of the outer frame 101, but this is merely an example. The transmission unit 11 and the reception unit 12 of the passenger detection device 1 may be disposed at a position on the upper side of the outer frame 101 depending on needs.

In the following first embodiment, the transmission unit 11 and the reception unit 12 of the passenger detection device 1 are also simply referred to as “passenger detection device 1”.

In FIG. 1A, the passenger detection device 1 is mounted on the upper side of the outer frame 101 in a state where the display device 10 is disposed, but this is merely an example. The passenger detection device 1 may be mounted on a place other than the upper side of the outer frame 101.

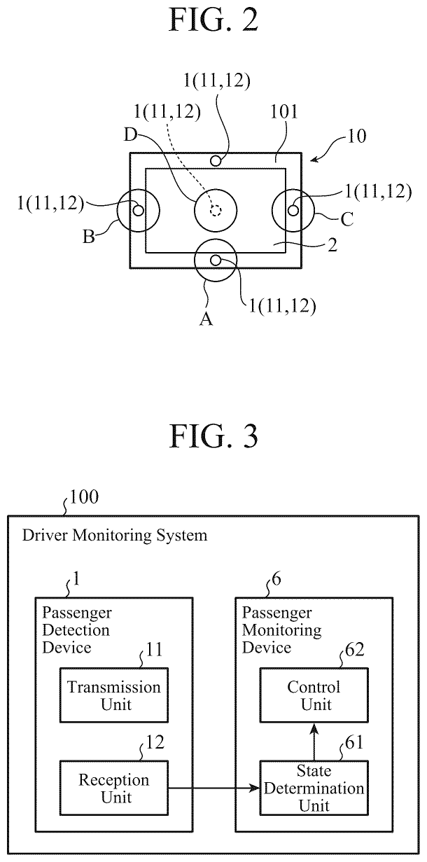

Here, FIG. 2 is a diagram for describing examples of the display device 10 in each of which the passenger detection device 1 is mounted on a place other than the upper side of the outer frame 101 in the first embodiment. Note that, in FIG. 2, only the display device 10 is illustrated, and the instrument panel 41 and other components are not illustrated for simplicity of description.

For example, the passenger detection device 1 may be mounted on a lower side of the outer frame 101 in a state where the display device 10 is disposed (see A of FIG. 2). The passenger detection device 1 may be disposed at a position on the lower side of the outer frame 101 depending on needs.

In addition, for example, the passenger detection device 1 may be mounted on a left side of the outer frame 101 in a state where the display device 10 is disposed (see B of FIG. 2). The passenger detection device 1 may be disposed at a position on the left side of the outer frame 101 depending on needs.

In addition, for example, the passenger detection device 1 may be mounted on a right side of the outer frame 101 in a state where the display device 10 is disposed (see C of FIG. 2). The passenger detection device 1 may be disposed at a position on the right side of the outer frame 101 depending on needs.

In addition, for example, the passenger detection device 1 may be mounted on a back surface side of the display unit 2 in the display device 10 (see D of FIG. 2). The passenger detection device 1 may be disposed at a position on the back surface side of the display unit 2 in the display device 10 depending on needs. The display unit 2 transmits a radio wave.

Note that, in FIG. 2, for convenience of description, all of the passenger detection devices 1 disposed on the upper side of the outer frame 101, the lower side of the outer frame 101, the left side of the outer frame 101, the right side of the outer frame 101, and the back surface side of the display unit 2 are illustrated. However, one passenger detection device 1 only needs to be mounted on at least one of the upper side of the outer frame 101, the lower side of the outer frame 101, the left side of the outer frame 101, the right side of the outer frame 101, and the back surface side of the display unit 2 in the display device 10.

For example, in a case where the vehicle 1000 is a right-hand drive vehicle as illustrated in FIGS. 1A and 1B, a radio wave coming from the passenger detection device 1 mounted on the right side of the outer frame 101 may be blocked by a steering wheel. Therefore, in this case, the passenger detection device 1 can detect the passenger with higher accuracy when being mounted on a place other than the right side of the outer frame 101 than when being mounted on the right side of the outer frame 101.

Conversely, in a case where the vehicle 1000 is a left-hand drive vehicle, the passenger detection device 1 can detect the passenger with higher accuracy when being mounted on a place other than the left side of the outer frame 101 than when being mounted on the left side of the outer frame 101.

In addition, for example, in a case where an operation panel of an air conditioner or the like is disposed below the display device 10, the passenger may extend his or her hand in order to operate the operation panel. In this case, a radio wave coming from the passenger detection device 1 may be blocked by the hand of the passenger operating the operation panel. Therefore, in this case, the passenger detection device 1 can detect the passenger with higher accuracy when being mounted on a place other than the lower side of the outer frame 101 than when being mounted on the lower side of the outer frame 101.

As described above, in the display device 10, the display unit 2 can be easily visually recognized by both the driver 511 and the assistant driver's seat passenger 512 to be detected by the passenger detection device 1. The position at which the display unit 2 can be easily visually recognized by both the driver 511 and the assistant driver's seat passenger 512 means a position at which the driver 511 and the assistant driver's seat passenger 512 can visually recognize the display unit 2 without changing their postures, and a position at which the driver 511 and the assistant driver's seat passenger 512 can be easily observed from the front.

By being mounted on the display device 10, the passenger detection device 1 is disposed at a position where the passenger can be easily observed from the front, in other words, at a position where the passenger detection device 1 is preferably disposed.

In addition, by being mounted on the display device 10 disposed at the center in the vehicle width direction, the passenger detection device 1 can detect the driver 511 and the assistant driver's seat passenger 512 at a time.

In addition, since the passenger detection device 1 is mounted on the display device 10, electric components such as a substrate or mechanical components can be shared by the passenger detection device 1 and the display device 10. In addition, a space for disposing the passenger detection device 1 in the vehicle interior is unnecessary, and space saving can be achieved. In addition, a dead space in the outer frame 101 of the display device 10 can be utilized.

A driver monitoring system including the passenger detection device 1 according to the first embodiment will be described.

FIG. 3 is a diagram illustrating a configuration example of a driver monitoring system 100 according to the first embodiment.

In the first embodiment, the passenger detection device 1 and a passenger monitoring device 6 constitute the driver monitoring system 100.

The passenger monitoring device 6 is mounted on the vehicle 1000 and includes a state determination unit 61 and a control unit 62.

The state determination unit 61 determines a state of a passenger on the basis of a reflected radio wave received by the reception unit 12 of the passenger detection device 1.

The state determination unit 61 outputs information regarding the determined state of the passenger (hereinafter, referred to as “passenger state information”) to the control unit 62.

When the passenger state information is output from the state determination unit 61, the control unit 62 performs control based on the state of the passenger determined by the state determination unit 61.

Determination of the state of the passenger performed by the state determination unit 61 and control based on the state of the passenger performed by the control unit 62 will be described with specific examples.

For example, the state determination unit 61 determines heartbeat or respiration of the passenger on the basis of a reflected radio wave received by the reception unit 12. Specifically, the state determination unit 61 determines whether or not there is a sudden change in physical condition of the passenger from the heartbeat or respiration of the passenger. For example, in a case where the passenger is the driver 511, the state determination unit 61 determines whether or not the driver 511 is in a state suitable for driving from the heartbeat or respiration of the driver 511.

When determining that the heartbeat or respiration of the passenger is in an abnormal state such as a state in which the passenger is in a poor physical condition or a state in which the passenger is not suitable for driving, the state determination unit 61 outputs passenger state information indicating that the state of the passenger is an abnormal state to the control unit 62.

When the passenger state information indicating that the state of the passenger is an abnormal state is output from the state determination unit 61, the control unit 62 outputs an alarm from, for example, an output device (not illustrated). The output device is assumed to be, for example, a sound output device such as a speaker mounted on the display unit 2 or the vehicle 1000. For example, the control unit 62 causes the display unit 2 to display a message prompting a break. In addition, for example, the control unit 62 causes the sound output device to output a warning sound.

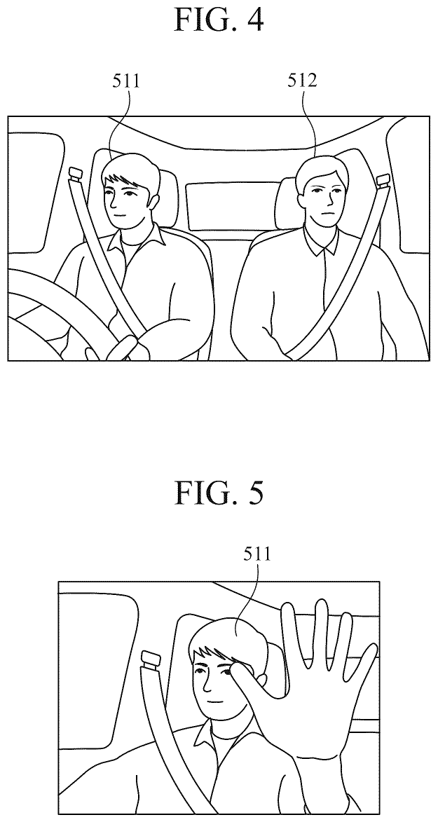

FIG. 4 is a diagram illustrating an example of a state of a vehicle interior as viewed from the display device 10 in the first embodiment.

As illustrated in FIG. 4, the display device 10 is disposed at a position facing the driver 511 and the assistant driver's seat passenger 512 in such a manner that the display unit 2 can be easily visually recognized by both the driver 511 and the assistant driver's seat passenger 512. That is, the passenger detection device 1 mounted on the display device 10 is also disposed at a position facing the driver 511 and the assistant driver's seat passenger 512.

In the passenger detection device 1, a radio wave transmitted by the transmission unit 11 is emitted to the chest and abdomen of the driver 511 or the assistant driver's seat passenger 512, and the reception unit 12 receives a reflected radio wave coming from the chest and abdomen of the driver 511 or the assistant driver's seat passenger 512. Therefore, the passenger detection device 1 easily detects movement of the chest and abdomen of the driver 511 or the assistant driver's seat passenger 512. That is, the state determination unit 61 can accurately determine heartbeat or respiration of the driver 511 or the assistant driver's seat passenger 512 on the basis of the reflected radio wave received by the passenger detection device 1.

In addition, for example, the state determination unit 61 determines a gesture performed by the passenger on the basis of the reflected radio wave received by the reception unit 12.

For example, the passenger can operate an adjustment unit for adjusting a volume of music or the like or an adjustment unit for adjusting a temperature or an air volume of an air conditioner, displayed on the display unit 2, by performing a gesture of moving his or her hand left and right or up and down without directly touching the display unit 2.

The state determination unit 61 determines what kind of operation the passenger intends to perform with the gesture on the basis of the reflected radio wave received by the reception unit 12.

When determining the gesture, the state determination unit 61 outputs information that can identify the determined gesture to the control unit 62, as passenger state information.

When the passenger state information that can identify the gesture is output from the state determination unit 61, the control unit 62 performs control corresponding to the gesture performed by the passenger. For example, in a case where the passenger performs a gesture of increasing a volume of music or the like, the control unit 62 increases a volume of a speaker. For example, in a case where the passenger performs a gesture of lowering a temperature of an air conditioner, the control unit 62 lowers the temperature of the air conditioner.

When the control unit 62 has performed the control, the control unit 62 may cause the display unit 2 to display a message indicating that the control has been performed.

For example, in a case where the driver 511 performs a gesture during driving, his or her hand is released from a steering wheel at the moment of performing the gesture. However, since the passenger detection device 1 that detects the gesture is mounted on the display device 10, the driver 511 does not need to largely release his or her hand from the steering wheel during driving. As described above, the display device 10 is disposed in such a manner that the driver 511 can easily visually recognize the display unit 2. The manner that the driver 511 can easily visually recognize the display unit 2 means that the driver 511 can visually recognize the display unit 2 without changing his or her posture to an unnatural posture, and that the display device 10 is disposed at a position not being largely separated from the driver 511. By the passenger detection device 1 being mounted on the display device 10, the passenger detection device 1 is also disposed at a position not being largely separated from the driver 511, and the passenger detection device 1 can detect the gesture even though the driver 511 does not largely release his or her hand from the steering wheel during driving.

In addition, the passenger performs a desired operation with a gesture on the display unit 2 incorporating various operation functions without directly touching the display unit 2. If the passenger detection device 1 is disposed at a place separated from the display device 10, the passenger cannot perform a desired operation unless the passenger performs a gesture toward the passenger detection device 1 not related to the display unit 2 to be operated in such a manner that the passenger detection device 1 can detect the gesture.

By the passenger detection device 1 being mounted on the display device 10, the passenger can perform a desired operation with the same feeling as performing the desired operation by directly touching the display unit 2. By the passenger detection device 1 being mounted on the display device 10, the passenger can intuitively operate the display unit 2.

FIG. 5 is a diagram illustrating an example of a state in which a passenger is performing a gesture for performing a desired operation as viewed from the display device 10 in the first embodiment.

In FIG. 5, as an example, it is assumed that the passenger is the driver 511, and the driver 511 performs a gesture of opening his or her hand. Note that, in FIG. 5, only the driver 511 is illustrated and the assistant driver's seat passenger 512 is not illustrated for the sake of convenience.

Since the passenger detection device 1 is mounted on the display device 10, as illustrated in FIG. 5, the driver 511 only needs to perform a gesture toward the display device 10.

As described above, by the passenger detection device 1 according to the first embodiment being mounted on the display device 10, the passenger detection device 1 is disposed at a position where the passenger detection device 1 that detects the passenger is preferably disposed.

Note that, in the first embodiment, the passenger to be detected by the passenger detection device 1 is assumed to be the driver 511 or the assistant driver's seat passenger 512, but the passenger detection device 1 can further detect a passenger such as an infant left behind on a rear seat.

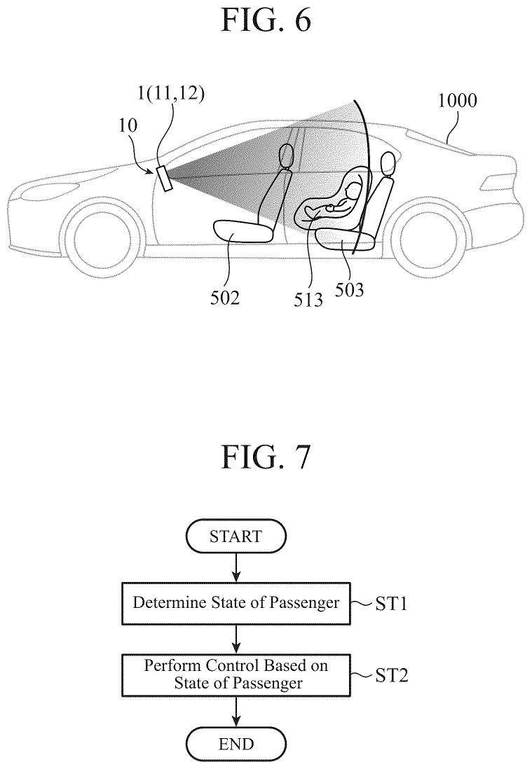

FIG. 6 is a diagram illustrating an example of a state in which the passenger detection device 1 detects an infant 513 left behind on a rear seat 503 in the first embodiment.

Note that FIG. 6 is a diagram of a vehicle interior of the vehicle 1000 as viewed from the assistant driver's seat 502 side. In addition, in FIG. 6, the outer frame 101 and the display unit 2 are not illustrated for simplicity of description.

For example, as described with reference to FIG. 4, the passenger detection device 1 is mounted on the display device 10 disposed on the instrument panel 41, and is disposed at a position facing the driver 511 and the assistant driver's seat passenger 512. That is, a radio wave transmitted from the transmission unit 11 of the passenger detection device 1 is emitted to the driver's seat 501 or the assistant driver's seat 502.

When the driver 511 or the assistant driver's seat passenger 512 gets off the vehicle 1000 and disappears from the vehicle interior, the radio wave transmitted from the transmission unit 11 of the passenger detection device 1 passes through the driver's seat 501 or the assistant driver's seat 502 and is emitted to the rear seat 503. Here, if the infant 513 is left behind in the rear seat 503 behind the driver's seat 501 after the driver 511 has disappeared or in the rear seat 503 behind the assistant driver's seat 502 after the assistant driver's seat passenger 512 has disappeared, a radio wave transmitted from the transmission unit 11 is reflected by the infant 513, and the reception unit 12 of the passenger detection device 1 receives a reflected radio wave. As described above, the passenger detection device 1 can also detect the infant 513 left behind on the rear seat 503.

Then, in the passenger monitoring device 6, the state determination unit 61 can determine that the infant 513 is left behind on the basis of the reflected radio wave received by the reception unit 12 of the passenger detection device 1. The state determination unit 61 outputs passenger state information indicating that the infant 513 is left behind in the vehicle interior, to the control unit 62. The control unit 62 outputs an alarm to, for example, an output device disposed in the vehicle 1000 or a communication terminal carried by the driver 511, on the basis of the passenger state information. As described above, in the driver monitoring system 100, the passenger monitoring device 6 can also monitor somebody left behind using the passenger detection device 1.

An operation of the passenger monitoring device 6 in the driver monitoring system 100 according to the first embodiment will be described.

FIG. 7 is a flowchart for describing the operation of the passenger monitoring device 6 according to the first embodiment.

The state determination unit 61 determines a state of a passenger on the basis of a reflected radio wave received by the reception unit 12 of the passenger detection device 1 (step ST1).

The state determination unit 61 outputs information regarding the determined state of the passenger (hereinafter, referred to as “passenger state information”) to the control unit 62.

When the passenger state information is output from the state determination unit 61 in step ST1, the control unit 62 performs control based on the state of the passenger determined by the state determination unit 61 (step ST2).

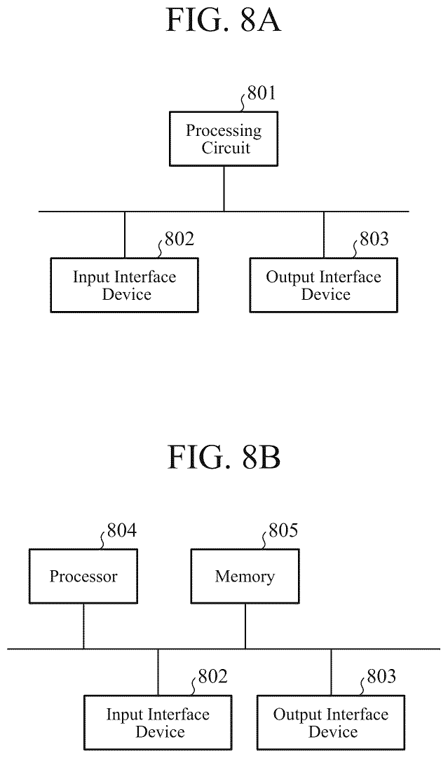

FIGS. 8A and 8B are each a diagram illustrating an example of a hardware configuration of the passenger monitoring device 6 according to the first embodiment.

In the first embodiment, functions of the state determination unit 61 and the control unit 62 are implemented by a processing circuit 801. That is, the passenger monitoring device 6 includes the processing circuit 801 for determining the state of the passenger on the basis of information regarding the reflected radio wave received by the passenger detection device 1 and performing control based on the determined state of the passenger.

The processing circuit 801 may be dedicated hardware as illustrated in FIG. 8A, or a processor 804 that executes a program stored in a memory as illustrated in FIG. 8B.

In a case where the processing circuit 801 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 801.

In a case where the processing circuit is the processor 804, the functions of the state determination unit 61 and the control unit 62 are implemented by software, firmware, or a combination of software and firmware. Software or firmware is described as a program and stored in a memory 805. By reading and executing the program stored in the memory 805, the processor 804 executes the functions of the state determination unit 61 and the control unit 62. That is, the passenger monitoring device 6 includes the memory 805 for storing a program that causes steps ST1 and ST2 illustrated in FIG. 7 described above to be executed as a result when the program is executed by the processor 804. It can also be said that the program stored in the memory 805 causes a computer to execute procedures or methods performed by the state determination unit 61 and the control unit 62. Here, for example, a nonvolatile or volatile semiconductor memory such as RAM, read only memory (ROM), flash memory, erasable programmable read only memory (EPROM), or electrically erasable programmable read-only memory (EEPROM), a magnetic disk, a flexible disk, an optical disc, a compact disc, a mini disc, or a digital versatile disc (DVD) corresponds to the memory 805.

Note that some of the functions of the state determination unit 61 and the control unit 62 may be implemented by dedicated hardware, and some of the functions may be implemented by software or firmware. For example, the function of the state determination unit 61 can be implemented by the processing circuit 801 as dedicated hardware, and the function of the control unit 62 can be implemented by the processor 804 reading and executing a program stored in the memory 805.

In addition, the passenger monitoring device 6 includes an input interface device 802 and an output interface device 803 that perform wired communication or wireless communication with a device such as the passenger detection device 1 or an output device.

Note that, in the first embodiment described above, the passenger monitoring device 6 is an in-vehicle device mounted on the vehicle 1000, and the state determination unit 61 and the control unit 62 are included in the in-vehicle device.

Not limited to this, for example, either one or both of the state determination unit 61 and the control unit 62 may be included in a server.

In addition, in the first embodiment described above, the display device 10 on which the passenger detection device 1 is mounted is fitted into the opening formed at the center of the instrument panel 41 in the vehicle width direction and on the rear surface of the instrument panel 41 in the front-rear direction of the vehicle 1000. However, this is merely an example. For example, the display device 10 may be erected on an upper surface of the center of the instrument panel 41 in the vehicle width direction.

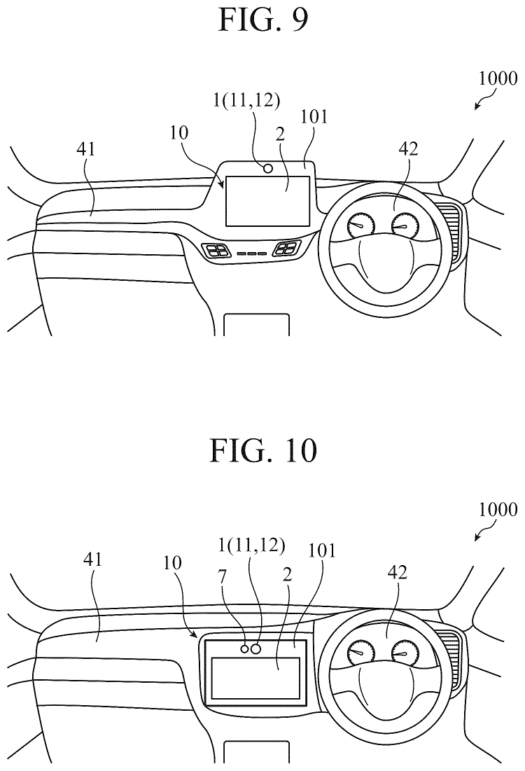

FIG. 9 is a front view of the entire instrument panel 41 in a case where the display device 10 on which the passenger detection device 1 is mounted in the vehicle 1000 is erected on the upper surface of the center of the instrument panel 41 in the vehicle width direction, in the first embodiment.

In the display device 10 illustrated in FIG. 9, the outer frame 101 is fixed to the instrument panel 41 and holds the display unit 2.

Note that, in FIG. 9, the passenger detection device 1 is mounted on an upper side of the outer frame 101 in the display device 10, but this is merely an example, and the passenger detection device 1 may be mounted on a lower side, a left side, or a right side of the outer frame 101, or on a back side of the display unit 2 in the display device 10.

In addition, in the first embodiment described above, the display device 10 on which the passenger detection device 1 is mounted is disposed on the instrument panel 41, but it is not limited thereto. The display device 10 may be disposed on, for example, a meter panel 42.

For example, in a case where the passenger whose state is to be monitored by the driver monitoring system 100 is limited to the driver 511, by the display device 10 being disposed on the meter panel 42, the display device 10 is located substantially in front of the driver 511. That is, the passenger detection device 1 is also located substantially in front of the driver 511. As a result, the passenger detection device 1 can detect the passenger with higher accuracy from a position closer to the driver 511 without anything to block a radio wave.

In the first embodiment, the display device 10 on which the passenger detection device 1 is mounted only needs to be disposed in such a way as to face a front seat ahead of the front seat.

In addition, in the first embodiment described above, in addition to the passenger detection device 1, an imaging device may be mounted on the display device 10. The imaging device is used in the driver monitoring system 100.

In the driver monitoring system 100, the passenger monitoring device 6 monitors a state of a passenger by combining an imaged image obtained by the imaging device imaging a vehicle interior and information regarding the passenger detected by the passenger detection device 1 (that is, a reflected radio wave).

As a specific example, for example, the passenger monitoring device 6 performs known image recognition processing on the imaged image, determines an eye opening degree of the passenger, and determines heartbeat or respiration of the passenger on the basis of a reflected radio wave. Then, the passenger monitoring device 6 determines whether or not the passenger is in an abnormal state, on the basis of the determined eye opening degree and the determined heartbeat or respiration. As a result, the passenger monitoring device 6 can monitor the state of the passenger with higher accuracy.

FIG. 10 is a front view of the entire instrument panel 41 in the vehicle 1000 in a case where the display device 10 on which the passenger detection device 1 and an imaging device 7 are mounted is disposed at the center of the instrument panel 41 in the vehicle width direction, in the first embodiment.

Note that, in FIG. 10, the display device 10 is disposed at the center of the instrument panel 41 in the vehicle width direction, but this is merely an example, and the display device 10 may be disposed on the meter panel 42.

In addition, in FIG. 10, the imaging device 7 is mounted on an upper side of the outer frame 101 in the display device 10, but this is merely an example, and the imaging device 7 may be mounted on, for example, a lower side, a left side, or a right side of the outer frame 101 in the display device 10.

By the imaging device 7 being mounted on the display device 10, a space for disposing the imaging device 7 in the vehicle interior is unnecessary, and further space saving can be achieved. In addition, a dead space in the outer frame 101 of the display device 10 can be further utilized.

As described above, the passenger detection device 1 according to the first embodiment is the passenger detection device 1 for detecting a passenger in a vehicle in which a display device is disposed in such a way as to face a front seat ahead of the front seat, and includes: the transmission unit 11 that is mounted on the display device 10 and transmits a radio wave to a vehicle interior; and the reception unit 12 that is mounted on the display device 10 and receives a reflected radio wave of the radio wave transmitted by the transmission unit 11. Therefore, the passenger detection device 1 is disposed at a position where the passenger detection device 1 is preferably disposed in the vehicle 1000.

In addition, the driver monitoring system 100 according to the first embodiment includes: the passenger detection device 1 mounted on the display device 10 disposed in such a way as to face a front seat ahead of the front seat; the state determination unit 61 that determines a state of a passenger on the basis of a reflected radio wave received by the passenger detection device 1; and the control unit 62 that performs control based on the state of the passenger determined by the state determination unit 61. Therefore, the driver monitoring system 100 can monitor the state of the passenger with high accuracy.

Note that, in the present disclosure, any component in the embodiment can be modified, or any component in the embodiment can be omitted.

### INDUSTRIAL APPLICABILITY

The passenger detection device according to the present disclosure is disposed at a position where the passenger detection device is preferably disposed in a vehicle.

### REFERENCE SIGNS LIST

1000: vehicle, 10: display device, 1: passenger detection device, 11: transmission unit, 12: reception unit, 2: display unit, 101: outer frame, 41: instrument panel, 42: meter panel, 501: driver's seat, 511: driver, 502: assistant driver's seat, 512: assistant driver's seat passenger, 503: rear seat, 513: infant, 6: passenger monitoring device, 61: state determination unit, 62: control unit, 7: imaging device, 801: processing circuit, 802: input interface device, 803: output interface device, 804: processor, 805:

memory

1. A passenger detection device to detect a passenger in a vehicle in which a display device is disposed in such a way as to face a front seat ahead of the front seat, the passenger detection device comprising:
a transmitter mounted on the display device, to transmit a radio wave to an interior of the vehicle; and
a receiver mounted on the display device, to receive a reflected radio wave of the radio wave transmitted by the transmitter, wherein
the display device includes a display and an outer frame surrounding an outer edge of the display, and
the transmitter and the receiver are mounted on an upper side of the outer frame or a lower side of the outer frame in a state where the display device is disposed.

2. (canceled)

3. (canceled)

4. The passenger detection device according to claim 1, wherein
the transmitter and the receiver are mounted on a left side of the outer frame in a state where the display device is disposed.

5. The passenger detection device according to claim 1, wherein
the transmitter and the receiver are mounted on a right side of the outer frame in a state where the display device is disposed.

6. The passenger detection device according to claim 1, wherein
the transmitter and the receiver are mounted on a back surface side of the display.

7. The passenger detection device according to claim 1, further comprising an imaging device disposed in such a way as to be able to image the front seat.

8. A driver monitoring system comprising:
the passenger detection device according to claim 1;
state determination circuitry to determine a state of the passenger on a basis of the reflected radio wave received by the receiver; and
control circuitry to perform control based on the state of the passenger determined by the state determination circuitry.

9. The driver monitoring system according to claim 8, wherein
the state determination circuitry determines heartbeat or respiration of the passenger on a basis of the reflected radio wave received by the receiver.

10. The driver monitoring system according to claim 8, wherein
the state determination circuitry determines a gesture performed by the passenger on a basis of the reflected radio wave received by the receiver.

11. A display device comprising
the passenger detection device according to claim 1.
